(19) United States
(12) Patent Application Publication
(10) Pub. No.: US 2026/0001970 A1
(43) Pub. Date: Jan. 1, 2026

(54) HIGH REFRACTIVE INDEX ADHESIVE FORMULATIONS FOR USE IN LASER AMPLIFIER CLADDING

(71) Applicant: Lawrence Livermore National Security, LLC, Livermore, CA (US)

(72) Inventors: Justin Adam Kerszulis, San Leandro, CA (US); Alan Ramirez, Bakersfield, CA (US)

(21) Appl. No.: 18/755,534

(22) Filed: Jun. 26, 2024

(51) Int. Cl. C08F 2/50; C08F 220/32; C08G 18/70; C08G 75/045; G02B 7/02

(52) U.S. Cl. CPC C08F 2/50; C08F 220/32; C08G 18/70; C08G 75/045; G02B 7/02

(57) ABSTRACT

A curable composition includes a thiol monomer, an epoxide monomer, and metal oxide nanoparticles. An amount of the metal oxide nanoparticles is effective to cause a mixture of the thiol monomer, epoxide monomer, and metal oxide nanoparticles to have a refractive index in a range of about 1.60 to about 1.80 after curing of the mixture, where the amount of the metal oxide nanoparticles is in a range of about 20 weight % to about 90 weight % of the total weight of the curable composition.

This invention was made with Government support under Contract No. DE-AC52-07NA27344 awarded by the United States Department of Energy. The Government has certain rights in the invention.

### FIELD OF THE INVENTION

The present invention relates to laser amplifier cladding, and more particularly, this invention relates to adhesive formulations having a high refractive index for laser amplifier cladding.

### BACKGROUND

Efforts to eliminate parasitic light oscillations (amplified spontaneous emission (ASE)) involve high energy laser systems that often utilize polymeric materials to adhere optically absorptive cladding materials to laser gain media (glass or crystal). There is a need for adhesives to index match between gain media and cladding which have applications in many high fluence, high repetition rate laser systems projects. For lasers that use high refractive index gain media (1.55 or above) there is a limited selection of optically transparent adhesives with matched refractive index to clad the components that also cure or harden to a suitable compliance (shore A hardness) to absorb stress from the component's operation. In some laser systems, there has been only one adhesive available commercially (e.g., Norland Products, Inc.) that has a Refractive Index (RI) of 1.64, however, has several drawbacks: weak adhesion, inconsistent curing, low viscosity, and is now discontinued. The adhesive material did not cure easily, and the adhesive material had a poor mechanical characteristic of being too soft and often did not hold components together. Existing technologies, for HAPLS for example, adhesives either suffer from low index (such as the case with conventional laser program urethanes (LPU) in the national ignition facility (NIF)) or from poor adhesion and cure (Norland 164).

Conventional methods of forming adhesives rely on acrylate-based molecules that include highly aromatic moieties or inorganic fillers for forming composites having high RI. The thin films formed with these products are nanometers (nm) thick and the color composite is yellow. Other adhesives are formed using elemental sulfur melt flow with di-allyl benzene forming sulfurous aromatic structures that have high RI, but the composites are also colored, e.g., yellow, orange, brown, etc. The composites are made at high temperatures, about 300° C., for the sulfur to melt, which is costly and not possible to make adhesives.

Other commercially available adhesives have color (e.g., yellow), relatively short pot lives, and are single component mixtures. Moreover, these adhesives are also not tailored specifically for laser cladding processes. Similar products used in LED lenses or displays include using a range of thiol-epoxies, such as thiol-urethanes, acrylates, etc. but cannot achieve the desired high RI, or in those that achieve the desired high RI, the products are colored, and alternatively if the material is optically clear then the material is very stiff.

One commercially available product, Norland 164, is a UV curable thiol-ene “click” based adhesive consisting of a multifunctional-thiol and a tri-ene wherein the structure was selected to achieve an intrinsically high RI based on the polarizability of the monomers. The formulation is partially index matched (n=1.64) to the Ti:Sapphire laser media (n=1.76) and Cu doped glass cladding. This adhesive was selected based only on the RI criteria and during production of the HAPLS laser system the adhesive was found to be difficult to work with due to its low viscosity and step-growth UV-based curing kinetics. This was compounded by the optic architecture confounding engineer's ability to hand dose with UV-pen consistently on all facets and sides of the final optic (likely due to laser glass absorption of UV bands required to achieve proper dose). These suboptimal UV-curing conditions likely led to the poor adhesion of the films due to insufficient molecular weight build or inconsistent network formation. Moreover, the formulation has also been discontinued.

Laser gain media could be cladded with absorptive glass using direct bonding or cold condensation through surface hydroxyl groups, but the resulting solid slab lacks a soft interlayer layer to take up stress from thermal cycling under lasing, this technology has also been exceedingly difficult to resurrect.

There is a need for an adhesive that is colorless, adequately soft, cures with minimal out gassing, and exhibits high RI with low haze, as well as being a formulation that is amenable to current optical potting processes. Many of these properties directly oppose one another, so finding a balance in one formulation has been an ongoing challenge.

### SUMMARY

According to one embodiment, a curable composition includes a thiol monomer, an epoxide monomer, and metal oxide nanoparticles. An amount of the metal oxide nanoparticles is effective to cause a mixture of the thiol monomer, epoxide monomer, and metal oxide nanoparticles to have a refractive index in a range of about 1.60 to about 1.80 after curing of the mixture, where the amount of the metal oxide nanoparticles is in a range of about 20 weight % to about 90 weight % of the total weight of the curable composition.

According to another embodiment, a cured adhesive product includes a thiol-epoxy polymer network, and metal oxide particles present in the polymer network in an effective amount to cause the cured adhesive product to have a refractive index in a range of about 1.60 to about 1.80. The cured adhesive product is optically transparent and has a hardness in a Shore A range of greater than 50 to less than 90.

According to yet another embodiment, a method includes obtaining a composition of a thiol monomer, an epoxide monomer, and a predefined amount of metal oxide particles, where an amount of the metal oxide particles is effective for causing the composition to have a refractive index in a range of about 1.60 up to about 1.80 upon curing of the composition. A catalyst is added to the composition; and the composition is cured to form a polymer network having the refractive index and a hardness in a Shore A range of greater than 50 and less than 90.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 is a schematic drawing of optic architecture using adhesive between cladding and gain media. Part (a) depicts amplified spontaneous emission in laser systems, part (b) depicts effect of increasing RI of adhesive, according to one embodiment.

FIG. 2 depicts optimal properties for an adhesive, according to one embodiment. Part (a) is a schematic drawing of the optimal properties, and part (b) is a plot refractive index vs. hardness of current adhesive formulations.

FIG. 3A is a schematic diagram of candidate monomers, according to one embodiment. Part (a) illustrates Part A thiol monomer candidates, part (b) illustrates Part B candidates for thiol-urethane polymer networks.

FIG. 3B is a schematic diagram of candidate monomers, according to one embodiment. Part (a) illustrates Part B candidates for thiol-ene-click polymer networks, part (b) illustrates Part B candidates for thiol-epoxy polymer network, and part (c) illustrates Part B candidates being more polarizable epoxide monomers.

FIG. 4 is a flow chart of a method of forming an adhesive product, according to one embodiment.

FIG. 5 is a schematic drawing of a method of forming an adhesive product, according to one embodiment.

FIG. 6 is a plot refractive indices of a series of thiol-epoxy polymer network formulations having increasing amounts of zirconia nanoparticles, according to one embodiment.

FIG. 7 depicts physical properties of thiol-epoxy polymer network with zirconia formulations, according to one embodiment. Part (a) is an image of a series of formulations compared to conventional epoxy adhesives, and part (b) is a plot of transmittance of the products versus wavelength.

FIG. 8 is a series of images of zirconia nanoparticles added to a known adhesive, LPU. Part (a) is an image of the nanoparticles in a polyol, and part (b) is an image of nanoparticles+polyol in LPU increasing concentration compared to nanoparticles in ethanol.

FIG. 9A is a series of images of thiol-urethane and thiol-ene-click formulations, according to one embodiment. Part (a) depicts thiolated monomer diisocyante mixtures, part (b) depicts disulfide containing polyol mixed with diisocyanates, and part (c) depicts samples of thiol-urethane, thiol-ene-click, and unfiled epoxy polymer networks.

FIG. 9B is an image of thiol-ene-click formulations with zirconia nanoparticles, according to one embodiment.

FIG. 10 is a summary of properties of various polymer formulations described herein, according to various embodiments. Part (a) is a plot of refractive indices of the polymer compared to silica, LPU, and conventional epoxy products. Part (b) is a table of hardness of the polymer formulations in terms of Shore A and D.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

For the purposes of this application, room temperature is defined as in a range of about 20° C. to about 25° C.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

A “nano” dimension or descriptor such as nanoscale, nanoporous, etc. is defined as having a diameter or length (e.g., a pore having an average diameter) less than 1000 nanometers (nm). A “micro” dimension or descriptor such as microscale, microporous, micron-sized, etc. is defined as having a diameter or length (e.g., a pore having an average diameter) less than about 1000 microns (μm).

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

A Shore A hardness scale ranges from 1 to 100. The Shore A hardness scale measures the hardness of flexible mold rubbers that range in hardness from very soft and flexible to medium and somewhat flexible, to hard with almost no flexibility at all. For example, a Shore A hardness of 20 (soft) may represent a rubber band, a Shore A hardness of 40 (medium soft) may represent a pencil eraser, a Shore A hardness of 70 (medium hard) may represent a tire tread, and a Shore A hardness of 90 (hard) may represent a shopping cart wheel.

Unless expressly defined otherwise herein, each component listed in a particular approach may be present in an effective amount. An effective amount of a component means that enough of the component is present to result in a discernable change in a target characteristic of the resin, ink, mixture, thermosets, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The following description discloses several preferred embodiments of curable composition formulations to obtain a high refractive index adhesive for use in laser amplifier cladding and/or related systems and methods.

In one general embodiment, a curable composition includes a thiol monomer, an epoxide monomer, and metal oxide nanoparticles. An amount of the metal oxide nanoparticles is effective to cause a mixture of the thiol monomer, epoxide monomer, and metal oxide nanoparticles to have a refractive index in a range of about 1.60 to about 1.80 after curing of the mixture, where the amount of the metal oxide nanoparticles is in a range of about 20 weight % to about 90 weight % of the total weight of the curable composition.

In another general embodiment, a cured adhesive product includes a thiol-epoxy polymer network, and metal oxide particles present in the polymer network in an effective amount to cause the cured adhesive product to have a refractive index in a range of about 1.60 to about 1.80. The cured adhesive product is optically transparent and has a hardness in a Shore A range of greater than 50 to less than 90.

In yet another general embodiment, a method includes obtaining a composition of a thiol monomer, an epoxide monomer, and a predefined amount of metal oxide particles, where an amount of the metal oxide particles is effective for causing the composition to have a refractive index in a range of about 1.60 up to about 1.80 upon curing of the composition. A catalyst is added to the composition; and the composition is cured to form a polymer network having the refractive index and a hardness in a Shore A range of greater than 50 and less than 90.

A list of acronyms used in the description is provided below.
3D three-dimensional
ASE amplified spontaneous emission
BADGE Bisphenol A diglycidyl ether
LPU laser program urethanes
MEK methyl ethyl ketone
MO metal oxide
MONP metal oxide nanoparticles
NDGE neopentyl glycol diglycidyl ether
nm nanometer
RI refractive index (indices)
SA Shore A
UV ultraviolet
wt. % weight percent

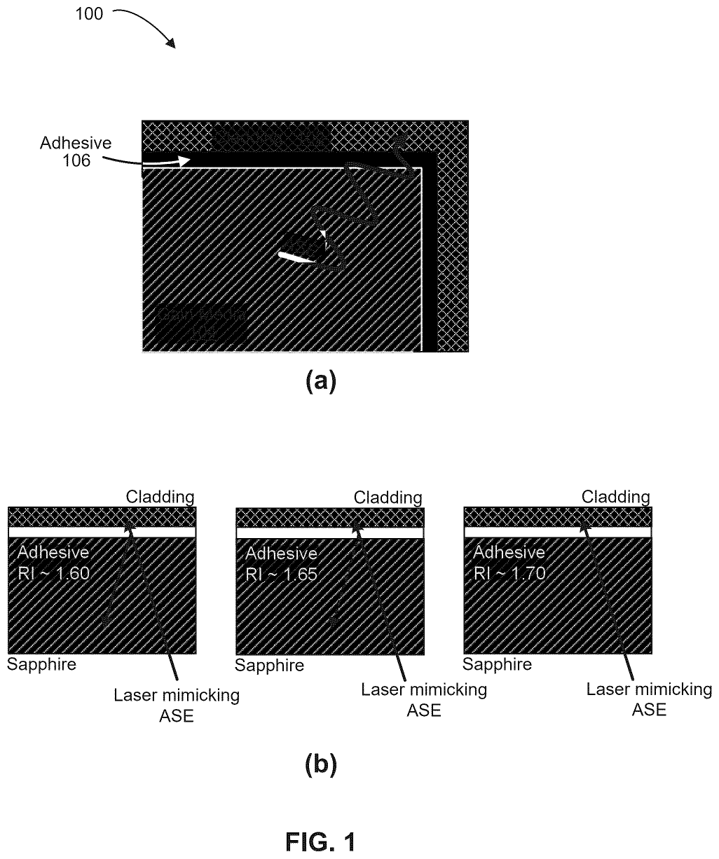

An example of a cladding system is illustrated in the schematic drawing of an optic architecture 100 in part (a) of FIG. 1, cladding 102 is adhered to gain media 104 with an adhesive 106. Preferably, the adhesive 106 is a polymeric material that enables amplified spontaneous emission (ASE) suppression in laser systems. Most of these polymeric optical adhesives are index matched to lower index gain media; however, an adhesive having a lower RI may contribute to reflection of the ASE back into the gain the sapphire (i.e., gain media). Currently available adhesives do not demonstrate an ability to achieve refractive indices (RI) greater than 1.60 with low color, while also maintaining mechanical compliance to serve as adhesives for cladding applications. As illustrated in the schematic drawings of part (b) of FIG. 1, complete suppression of ASE may occur with adhesives having progressively increasing RI, e.g., greater than 1.60, with the adhesive being positioned between gain media (e.g., sapphire) and cladding. Where the laser mimics ASE, an adhesive with an RI of about 1.60 (left panel) does not demonstrate significant suppression of ASE, whereas an adhesive with an RI of about 1.65 (middle panel) and an adhesive with an RI of about 1.70 (right panel) demonstrate significant suppression to complete suppression, respectively, of the ASE.

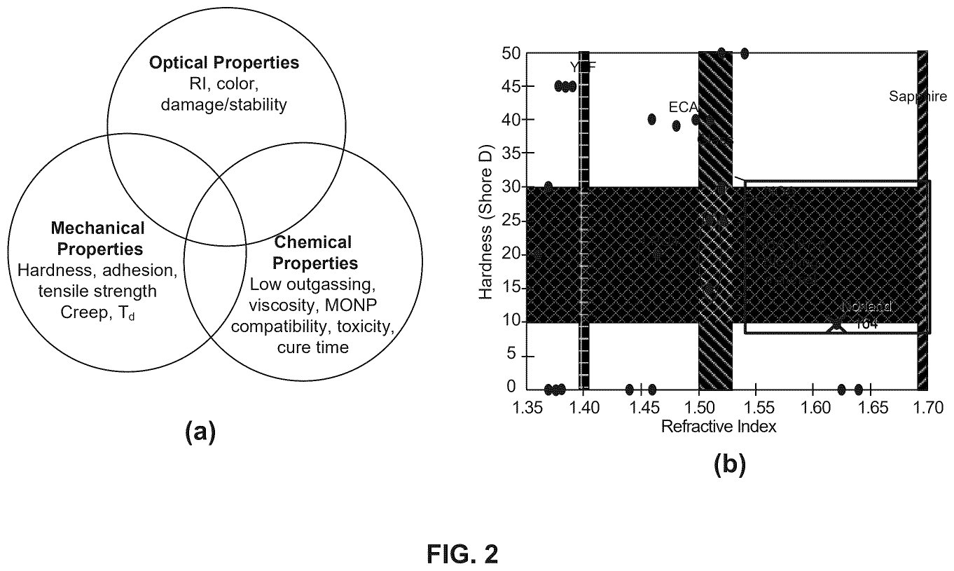

As described herein, various embodiments describe balancing disparate properties to achieve adhesives having suitable high RI. Part (a) of FIG. 2 illustrates that an adhesive having a suitable high RI preferably includes optical properties (e.g., RI, low color, resistance to damage, stability), mechanical properties (e.g., hardness, adhesion, tensile strength, creep, degradation temperature (Ta), and chemical properties (e.g., low outgassing, viscosity, MONP compatibility, toxicity, cure time). In terms of polymer hardness and refractive index, the plot in part (b) illustrates a potential region of properties for hardness (e.g., between Shore D 10 to 30) and refractive index between glass and sapphire (e.g., between about 1.55 up to 1.7) for polymer candidates for the adhesion material. Already indicated on the plot are the conventional polymers such as laser program urethanes (LPU) (low RI) and ECA (mechanically stiff, high Shore D hardness), and Norland 164 that has been discontinued.

According to one embodiment, several chemistry strategies have been developed that may allow fabrication of a suitable high RI adhesives that can be tuned to suit future laser cladding requirements. A first strategy included loading high refractive index metal oxide nanoparticles into current high performing conventional urethane formulations. This early approach included an addition of metal oxide nanoparticles (MONPs, such as zirconia, titania, etc.) to a conventional laser program urethane (LPU) formulation process. As a conventional adhesive, the LPU formulation has well understood mechanical, laser, and thermal performance. It was hypothesized that loading a desired level of zirconia may raise the average RI of the LPU formulation to at least 1.64. However, repeated attempts to disperse zirconia nanoparticles in the LPU formulation were unsuccessful and formed gelatinous intractable masses. The MONPs could not be dispersed into the LPU formulation; the material remained out of solution due to the polyol configuration of LPU (but not the isocyanate). Thus, the conventional LPU formulation was not pursued.

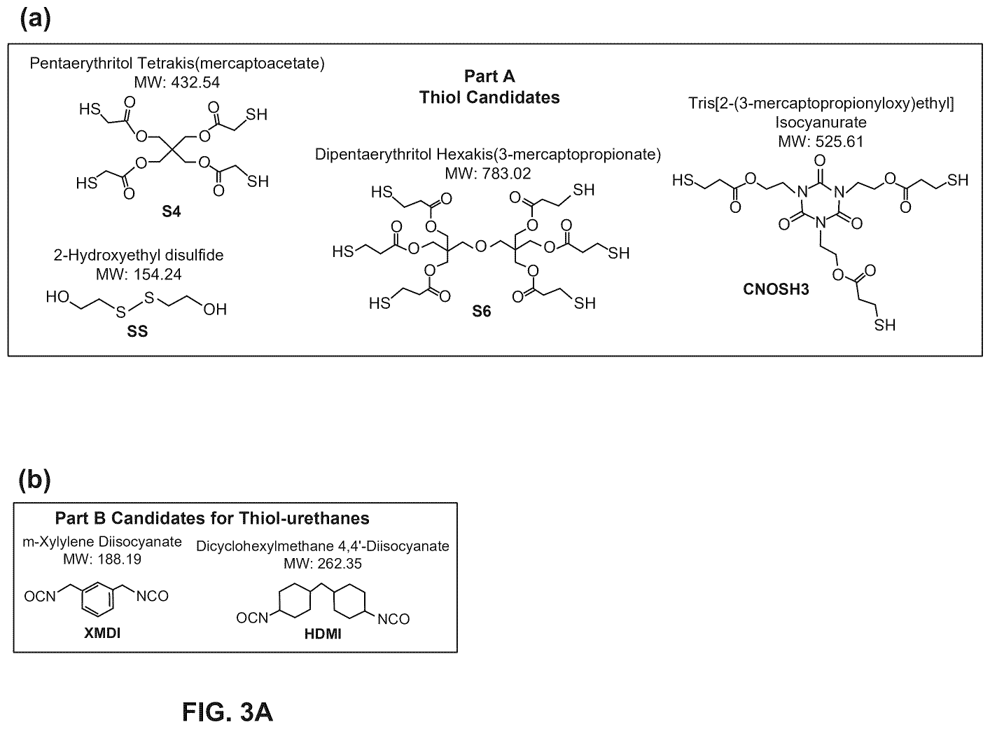

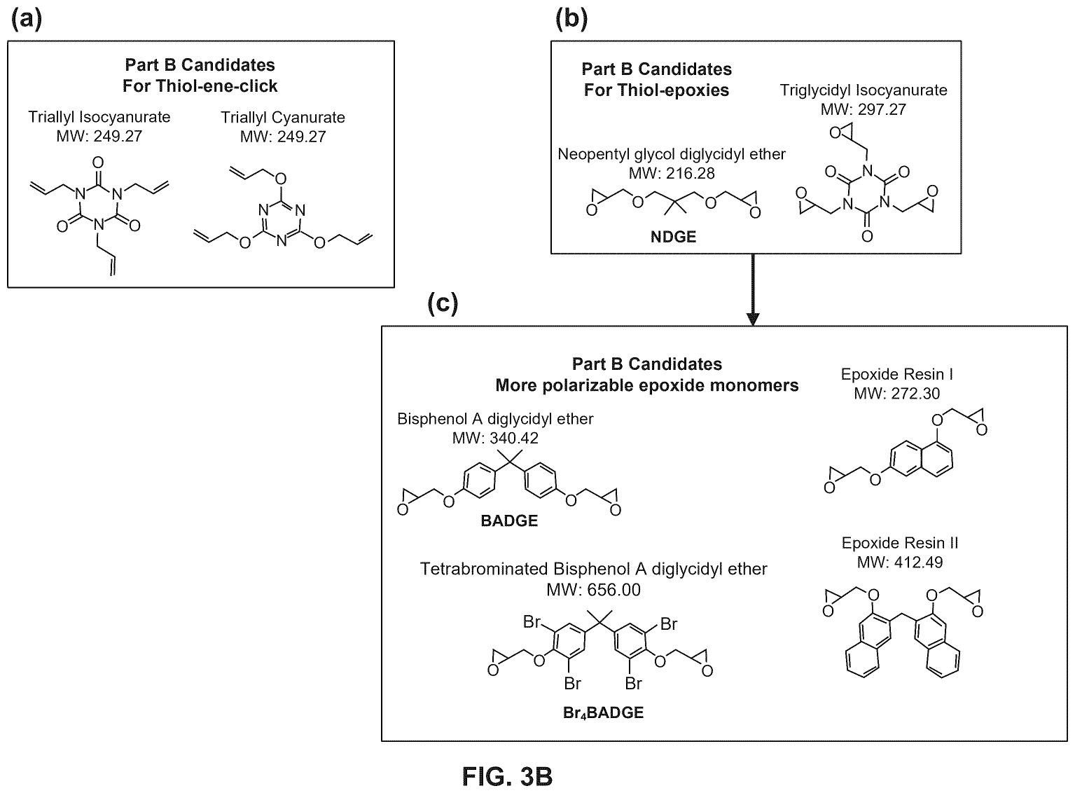

The second strategy included using the electronic polarizability of legacy materials to produce novel urethane networks. This strategy does not include adding a metal oxide filler. The electronic polarizability of the starting monomers may be possible by adding organic moieties containing pi-conjugation, sulfur, or heavy atoms such as bromine, as illustrated in examples of starting monomers in FIGS. 3A and 3B.

In one approach, a potential adhesive product may be fabricated by forming a polymer network using a curable composition that includes monomers that are easily miscible with no solvents that allows the composition to be cured into a film or object that is optically transparent within days at room temperature or rapidly at elevated temperature or under UV light, be mechanically soft (Shore A hardness of 40 to 95) and have a minimum RI of 1.64 or greater. Design strategies included common molecular designs that involve changing the overall molar refractivity of a polymer network utilizing the Clausius-Mossotti relation. In one instance, the Lorenz-Lorenz equation that defines the relationship between RI and polymer composition may identify candidate monomers for a curable composition. For example, a desired monomer may have polarizable chemistries in sufficient amounts while having a low free volume. Sulfur moieties are known to raise RI in cured polymers.

In various approaches, a curable composition is configured to form a polymer network. In one exemplary approach, a curable composition is configured to form a thermosetting network. In a preferred approach, a thermoset network is based on thiols and epoxies. In some formulations, a thermoset network may be based on multiple thiol monomer components and epoxy monomer components. Hybrid structures may include polyols that are compatible with metal oxide nanoparticles. In one example, the polymer network may be a homopolymer, being a single straight chain, where repeating units include an epoxide unit and a thiol unit in one monomer or one regular repeating unit (e.g., AAAAAAAAAA vs ABABABABAB). In another example, the polymer network may be a copolymer having two different monomers either in block form (AAAAABBBBB) or random (ABABABAAABBA). The polymer network may be formed by crosslinks between chains of the homopolymer, copolymer, etc.

A principal consideration of selecting monomers included avoiding functional groups that may cause discoloration of the adhesive product over time. Sulfur oxidation over life of adhesive may affect RI and coloration. Poor stability or reactivity of aryl alcohols, phenolic systems may photo-oxidize into colored quinones.

A curable composition may include monomers that may be cured to synthesize a variety of thiol-epoxy crosslinked polymer networks filled with zirconia nanoparticles. Examples of monomers are illustrated in FIGS. 3A and 3B. A combination of monomers for forming an adhesive includes

Part A thiol (SH) monomer+Part B monomer=a thiol polymer network.

The Part A+B combinations formed thiol-urethane polymer networks, thiol-ene-click polymer networks, and thiol-epoxy polymer networks. FIG. 3A illustrates Part A candidate thiol (SH) monomers. In preferred approaches, a thiol monomer exists as a liquid at room temperature. The thiol monomer has a high boiling point so that the thiol monomers do not off gas easily. In preferred approaches, the thiol monomer has a boiling point in a range of 200° C./1 mmHg to 300° C./1 mmHg, preferably in a range of 245° C./1 mmHg to 275° C./1 mmHg. A thiol monomer having a boiling point lower than 200° C./1 mmHg may likely fail outgassing requirements, and a thiol monomer having a boiling point higher than 300° C./1 mmHg may likely decompose. Part B monomers that react with the thiol monomer of Part A to form a urethane polymer network are illustrated in FIGS. 3A and 3B. Preferably, the monomers exist as a solvent. Preferably, no solvent is present in the mixture during curing. Preferably, for fabricating adhesives, the monomers are liquids at room temperature to process into optic architectures, are colorless and not toxic to operators conducting the build operations, and the monomers do not include any solvents (i.e., commonly referred to as 100% solids adhesives).

In one approach, a curable composition for forming a cured adhesive may include commercially available monomers that form thiol-urethanes, thiol-ene click, acrylate, and epoxy polymer networks. Initial approaches included forming a urethane polymer network with diisocyanates and polyols. These reactions were not productive, so a next approach included forming a urethane polymer network by reacting thiols with diisocyanates. Referring to candidate Part B monomers for forming thiol-urethane polymer networks (FIG. 3A), the resulting thiol-urethanes polymer networks have undesirable properties that detract from being practical components of a curable composition, such as, not being miscible with neat diisocyanates, forming vibrant colors, having an exothermic cure with emanation of noxious vapors (potential hazard to build operators), etc.

In one approach, a curable composition having thiol (monomers as Part A) and HDMI (Part B) resulted in cured polymer networks having RIs that tend to be below 1.60 and the Shore A hardness in the 90s. In another approach, combining XMDI (Part B) with thiol monomers (Part A) resulted in higher RI, however, the reaction can be very exothermic at extremely low levels of catalyst. Alternatively, curable compositions that form thiol-urethane polymers are castable and form castings with RI between 1.60-1.64. Thiol-urethanes may have potential; however, some formulations are highly volatile and potentially dangerous in application (e.g., toluene diisocyanates, m-xylene diisocyanate, etc.).

Consideration of acrylates as a component of a curable composition yielded similar limits with RI tuning comparable to the exploration into thiol-ene click polymer network, however, acrylates added complexity of having to consistently remove quinone-based inhibitors present in many monomers which contribute to color formation and complicate curing kinetics from batch to batch.

Another early approach included curable compositions that relied on reactive thiols using thiol-ene-click to generate multifunctional alkenes, thiols, etc. that are UV-cured. In this approach, a catalyst may not be included. Referring to candidate Part B monomers for forming thiol-ene-click comonomers (FIG. 3B), however, the cured polymers tend to have lower RI of less than 1.60. Adding metal oxide particles (e.g., zirconia) to the curable compositions that use the thiol-ene-click formulations is difficult because the compositions with zirconia turn opaque (i.e., white) after curing (e.g., UV exposure). However, the curing of the reaction tended to be efficient even under poor UV lamp.

Referring to epoxide candidates as Part B monomers for a curable composition (FIG. 3B), a wide range of epoxide molecules are available for reaction with thiols. An epoxide refers to a cyclic ether where the ether forms a three-atom ring: two atoms of carbon and one atom of oxygen. Preferably, the curable composition includes common liquid polyols, polythiols, etc. and epoxide monomers. The polymer formed from the epoxide precursors is called an epoxy. In preferred approaches, a curable composition that includes aromatic diepoxides (e.g., BADGE, FIG. 3B) resulted in a cured polymer product having a higher RI, e.g., above 1.60, compared to polymers formed having aliphatic epoxides (NDGE) that result in products having an RI in the mid-1.50's range. In some approaches, cured epoxy-based materials have properties of sufficient softness and RIs from 1.60 to 1.64 with no MONP filler.

In preferred approaches, a Part B candidate epoxide monomer does not include an amine. The presence of amine in an epoxide monomer may cause the curable composition to result in a cured product that has some color, tint, etc. In some approaches, an epoxide monomer may include an amine. For example, in some laser systems, materials are used in systems designed to exclude oxygen, and are used under vacuum, in the presence of inert gas (e.g., Ar, He, etc.), etc. so the presence of amines may not cause colorization of the product.

In some approaches, the epoxide monomer may be a hybrid monomer. For example, an epoxide monomer may include an acrylate, e.g., glycidyl acrylate monomer, that would form an acrylate epoxy.

Epoxides are typically used for engineering plastics, for materials having high glass transition temperatures. Epoxides have not been used for optics. It is known in the art that epoxides are known for coloration, so engineers, chemists, etc. avoid epoxides for the coloration property of turning orange, brown, etc. However, coloration in epoxides occur in reaction with polyols, glycol ethers, etc. that are amine terminated, or in epoxides used in the presence of a high concentration of amines, the oxidation of the amines causes the coloration. The cyclic ether rings of the epoxides do not cause the coloration of the formulation. Thus, an epoxide-containing formulation that does not include amine will have a stable colorless property.

A third strategy includes an approach to raise the RI of the composition above 1.60 by adding a metal oxide filler (e.g., nanoparticles) to the process by forming composites of comonomer networks. The proposed approach would likely yield a formulation with sufficiently high and tunable RI, while also being mechanically compliant enough to serve as an adhesive for cladding laser glasses. These strategies provide technical capability to better index match gain media to laser glass with a scalable and facile fabrication method.

According to one embodiment a curable composition includes a thiol monomer, an epoxide monomer, and metal oxide nanoparticles. An effective amount of the metal oxide nanoparticles causes a mixture of the thiol monomer, epoxide monomer, and metal oxide nanoparticles to have a refractive index in a range of about 1.60 to about 1.80 after curing of the mixture. The amount of the metal oxide nanoparticles may be in a range of about 20 wt. % to about 90 wt. % of the total weight of the curable composition. At high amounts of metal oxide nanoparticles, e.g., greater than 86 wt. %, the RI may reach 1.70; however, the material becomes brittle. An amount of 90 wt. % of metal oxide nanoparticles may allow a higher RI, however, the material may be too brittle for practical applications. In some approaches, the amount of metal oxide nanoparticles may be in a range of 20 wt. % to about 90 wt. % of the total weight of the mixture of monomers. Preferably, the amount of metal oxide nanoparticles may be in a range of 20 wt. % to 80 wt. % of the total weight of the mixture of monomers.

In various approaches, the thiol monomer has a molecular structure having at least two mercaptoacetate (HSCH2COO—) functional groups. As illustrated in FIG. 3A, part (a) illustrate several thiol monomers having at least two mercaptoacetate functional groups. In a preferred approach, the thiol monomer has a molecular structure having four mercaptoacetate groups. For example, Pentaerythritol Tetrakis(mercaptoacetate) (S4) is a thiol monomer having four mercaptoacetate groups. In preferred approaches, the thiol monomer is a liquid at room temperature. In some approaches, the thiol monomer is one of the following monomers: pentaerythritol tetrakis(mercaptoacetate), 2-hydroxyethyl disulfide, dipentaerythritol hexakis(3-mercaptopropionate), tris[2-(3-mercaptopropionyloxy)ethyl] isocyanurate, etc.

In various approaches, the epoxide monomer has a molecular structure having at least two ethylene oxide groups, i.e., two cyclic ether groups containing two carbons and an oxygen. In preferred approaches, the ethylene oxide groups are end groups on the epoxide monomer. In one approach, the epoxide monomer has an aromatic molecular structure. In some approaches, the epoxide monomer is one of the following: neopentyl glycol diglycidyl ether, triglycidyl isocyanurate, bisphenol A diglycidyl ether, and tetrabrominated bisphenol A epoxide.

According to various approaches, the metal oxide nanoparticles (MONPs) may include at least one of the following metal oxides: zirconia (ZnO₂), titania (TiO₂), hafnia (HfO₂), yttria (yttrium (III) oxide, Y₂O₃), tantala (tantalum pentoxide, Ta₂O₅), germania (germanium dioxide, GeO₂), ceria (cerium(IV) oxide, CeO₂), etc. The MONPS may include zirconia, titania, hafnia, etc. nanoparticles.

In one approach, the metal oxide nanoparticles are in the form of a powder. In a preferred approaches, an average diameter of the particles is in a range of 5 nm to 50 nm. In an exemplary approach, an average diameter of the MONPs may range from 5 nm to 20 nm. Preferably, the average size of the particles is smaller, less than 50 nm in diameter, to minimize haze and to increase the RI of the mixture. The electron cloud of the zirconia particles affects the optical properties of the mixture, e.g., haze, RI, etc. The smaller the electron cloud of the particles, the more advantageous for high RI and lower haze.

In one approach, the metal oxide nanoparticles may be the form of a metal oxide dispersion. Preferably, the metal oxide particles in a dispersion have an average diameter less than 50 nm. The metal oxide dispersion may be nanoparticles dispersed (i.e., suspended) in a carrier solvent, preferably a highly volatile carrier solvent. For example, the metal oxide nanoparticles may be dispersed in methyl ethyl ketone (MEK) that is removed from the mixture before curing.

In some approaches, the metal oxide nanoparticles may be pre-mixed in the monomer components of the curable composition. In a preferred approach, the metal oxide nanoparticles are dispersed in the epoxide monomer before addition to the thiol monomer. In one approach, the metal oxide nanoparticles may be pre-mixed in the epoxide monomer and exist as a mixture for greater than 6 months. For example, an epoxide monomer+metal oxide nanoparticle mixture may remain unchanged (e.g., do discoloration, spontaneous polymerization, etc.) at room temperature for a period greater than 180 days. Without wishing to be bound by any theory, dispersing the metal oxide nanoparticles in the thiol monomer causes the thiol monomer to have a less stable pot life from thiol self-polymerization. Without wishing to be bound by any theory, it is believed that the thiol may undergo linkage to the organic decorating groups around the MONP, at least in the case of acrylic acid based pendant groups.

Furthermore, the stability may be dictated by the stability of the organic pendant groups decorating the MONP. For example, particle manufacturer Pixelligent recommends 6 to 9 months of stability of MONP in MEK or ethyl acetate. In one example, titania nanoparticles in ethyl acetate became a gel after 5 months.

A variety of metal oxide nanoparticle (MONP) products may be obtained commercially. In one approach, various metal oxide materials are available commercially, e.g., from Pixelligent Technologies, Inc. (Baltimore, MD) where the metal oxide nanoparticles may be obtained in powder form, nanoparticles dispersed in a carrier solvent, nanoparticles dispersed in a desired solvent, etc.

According to one embodiment, the curable composition may also include a base catalyst for promoting a base-catalyzed thiol-epoxy reaction between the thiol monomer and the epoxide monomer.

According to various embodiments, the curable composition may include a curing agent, such as a photoinitiator and/or a thermal initiator. In some approach, the curing of the curable composition may include a thermal curing step to complete the curing process. However, the composition does not include an inhibitor to maintain a colorless composition. Preferably, inhibitors that typically have a color tint are not included in the curable composition.

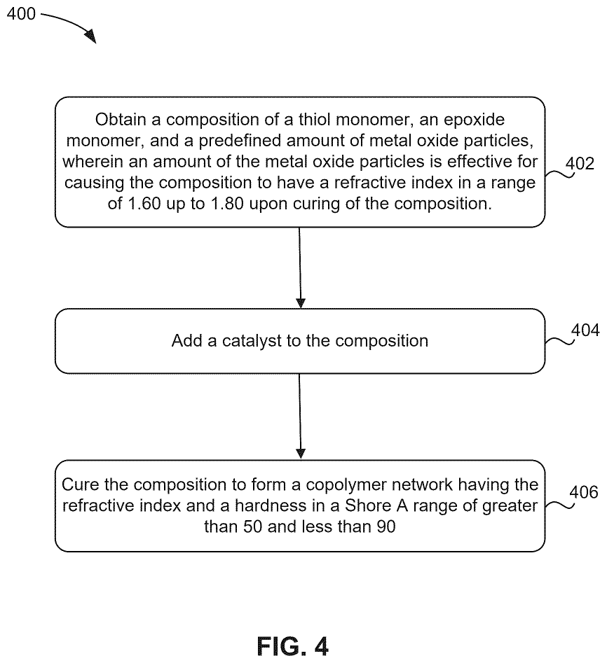

FIG. 4 shows a method 400, in accordance with one aspect of one inventive concept. As an option, the present method 400 may be implemented to construct structures such as those shown in the other FIGS. described herein. Of course, however, this method 400 and others presented herein may be used to form structures for a wide variety of devices and/or purposes which may or may not be related to the illustrative embodiments listed herein. Further, the methods presented herein may be carried out in any desired environment. Moreover, more or less operations than those shown in FIG. 4 may be included in method 400, according to various embodiments. It should also be noted that any of the aforementioned features may be used in any of the embodiments described in accordance with the various methods.

Method 400 may begin with operation 402 obtaining a composition of a thiol monomer, an epoxide monomer, and a predefined amount of metal oxide particles. The amount of metal oxide particles is a predefined amount to cause the adhesive product to have a refractive index in a range of 1.60 up to 1.80. In various approaches, an amount of metal oxide particles is effective for causing the composition to have a refractive index in a range of 1.60 up to 1.80 upon curing of the composition. The amount of metal oxide particles may be in a range of 20 wt. % up to 90 wt. % of total weight of the mixture of epoxide monomer and thiol monomer. In preferred approaches, the amount of metal oxide particles may be in a range of 30 wt. % to 70 wt. % of the mixture of monomers.

In some approaches, the metal oxide particles are of nanoscale. The metal oxide particles have an average diameter less than 50 nm. In one approach, a metal oxide dispersion comprised of metal oxide particles in a carrier solvent is mixed with one of the monomers before combining the monomers, e.g., the thiol monomer or the epoxide monomer. In one approach, the nanoparticles may be dispersed in a polyol and diisocyante monomer formulation. In some approaches, the metal oxide nanoparticles are dispersed in a carrier solvent that may be removed by vacuum, evaporation, etc. For example, a carrier solvent such as MEK may be stripped from the mixture under an application of vacuum using a rotary evaporator.

In one approach, an adhesive product is based on a method that includes a thiol monomer mixed with an epoxide monomer premixed with metal oxide nanoparticles. In one approach, the metal oxide material is dispersed in the epoxide monomer. Epoxide monomers are good solvents for dissolving metal oxide particles. It was surprising to note that zirconia remains stable in an epoxide monomer. Zirconia in an epoxide monomer do not cure, solidify, phase separate, etc. over time.

In another approach, the first operation of an adhesive forming method may be adding high RI metal nanoparticles (MONPs) in a carrier solvent (e.g., MEK) to a thiol monomer. The volatile carrier solvent may be removed by vacuum. Alternatively, the metal oxide particles may be dispersed in the thiol monomer. A catalyst for the thiol-epoxy reaction is added to the MONPs in the thiol monomer forming a mixture. An epoxide monomer (Part B) is added to the Part A mixture and the composite thiol-epoxy polymer network with metal oxide nanoparticles is formed. The cured adhesive material may be measured for optical and basic mechanical properties.

According to various approaches, a composition includes an amount of epoxide monomer to thiol monomer in a ratio by mole in terms of functionality where the ratio of the functionality of ethylene oxide (EO) in the epoxide monomer f_{EO} and the functionality of the thiol (SH) in the thiol monomer f_{SH} is preferably in a range of 0.5 to 2.0 f_{EO} to f_{SH}. In a preferred approach, a functionality ratio of ethylene oxide (EO) to thiol (SH) f_{EO}:f_{SH} is 1:1. The softness of the material may be adjusted according to the ratio of amounts of ethylene oxide in the epoxide monomer to thiol in the thiol monomer, such that an excess of ethylene oxide functional groups may decrease crosslink density.

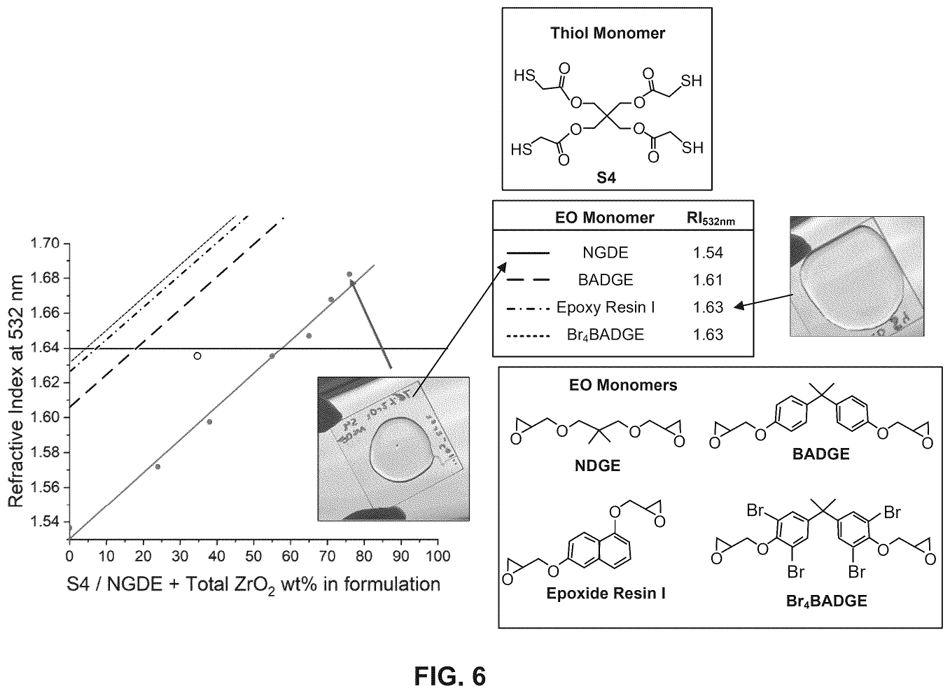

In an exemplary approach, an epoxide monomer has a functionality of 2 representing two ethylene oxide groups, (f_{EO})=2. For example, the epoxide NDGE has two ethylene oxide functional groups. A thiol monomer for the exemplary mixture of NDGE may preferably have 4 thiol units, (f_{SH})=4, (for an example see FIG. 6). To achieve a 1:1 ratio of f_{EO}:f_{SH}, the amount of NDGE, for example, would be to NDGE molecules for each thiol having a f_{SH}=4. Preferably, to decrease crosslink density for a softer material, an excess amount of epoxide monomers (f_{EO}=1 or 2) increases the ratio greater than 1:1. For a range of functionalities of the epoxide and thiol monomers, a range of the ratio of ethylene oxide functional units (f_{EO}) on the epoxide monomer to thiol functional units (f_{SH}) on the monomer may be 0.5 to 2.0 ratio, and may be higher than 2.0. In one approach, monoepoxides (f_{EO})=1, however, the monomer mixture may preferably include a comonomer epoxide having (f_{EO})=2 or greater depending on desired crosslink density.

In some approaches, the ratio of ethylene oxide (epoxide monomer) to thiol monomer generates a product having a Shore A in a range of 50 to 60, and then adding zirconia results in a product having a Shore A in a range of 70 to 80, depending on the amount to zirconia added, the extent of curing, etc.

Operation 404 includes adding a catalyst to the composition of thiol monomer, epoxide monomer, and metal oxide particles. The catalyst may be a base catalyst. In one approach, the base catalyst is triethylamine (TEA). Amines (e.g., primary, secondary, and tertiary amines) are efficient base catalysts for the thiol-epoxide reaction. In various approaches, a base catalyst is added in an effective amount to promote a base-catalyzed thiol-epoxy reaction between the thiol monomer and the epoxide monomer. An amount of base catalysts may be in a range of about 2500 to 5000 ppm per 20 g of monomer mixture. In another approach, the catalyst is an acid catalyst. For example, an acid catalyst may include Brønsted-Lowry acid such as carboxylic acids, Lewis acids such as Boron trifluoride, etc. The mixture is colorless and clear. In some approaches, the mixture may be degassed to remove bubbles from the mixture.

Operation 406 includes curing the composition to form a polymer network having the refractive index and a hardness in a Shore A range of greater than 50 and less than 90. The mixture may be deposited onto a surface (e.g., glass surface) as a film. The mixture may be cast in a mold. For example, the mixture may be cast into discs having a thickness of 100-200 mm. In a preferred approach, before curing, the method includes applying the composition with catalyst to a surface to be adhered to another surface by the cured composition. For example, the composition is applied to a surface of cladding and/or surface of gain media to adhere the cladding to the gain media.

In one approach, a curing agent may be added to the composition. In one approach the curing agent is a photoinitiator. In another approach, the curing agent is a thermal initiator. In one approach, mixture may be set at room temperature. In another approach, the mixture may be heated at an elevated temperature of about 80° C., a temperature used to build the AMP heads, so the material will be exposed to this temperature during building the apparatus. The material is highly compliant.

In one example, a thiol-epoxy-zirconia polymer network is cured into films, pucks, etc. thereby forming an optically transparent adhesive material that has an RI of about 1.60 to about 1.68 refractive index at 532 nm with varying shore A hardness in the range of 50 to 98.

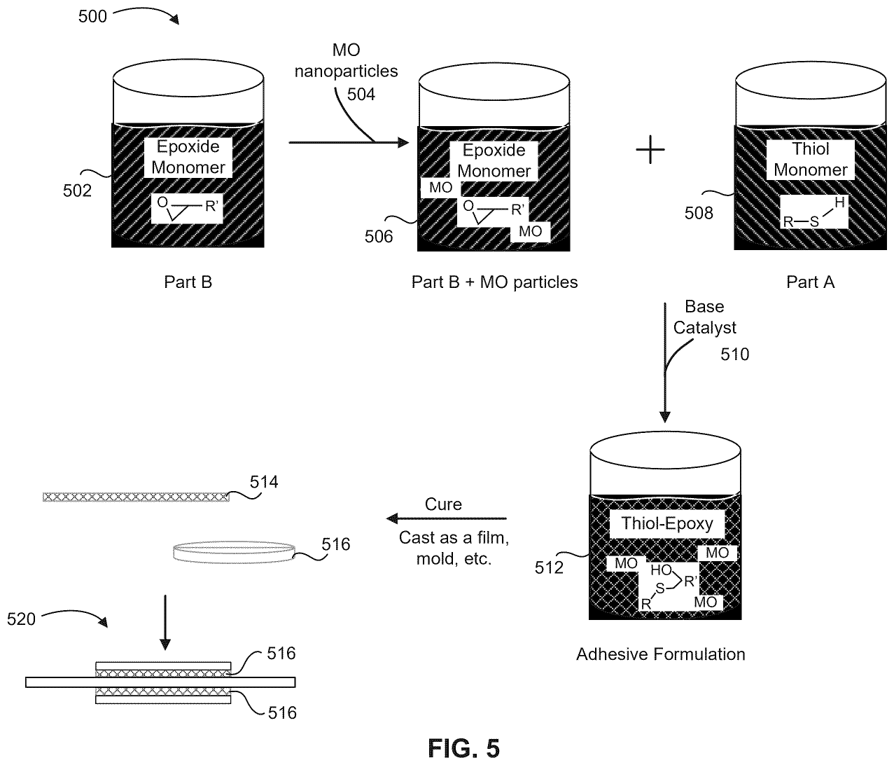

FIG. 5 illustrates one example of a method 500 of forming an adhesive product. Method 500 begin with obtaining an epoxide monomer 502 according to the preferences described herein. The epoxide monomer is preferably a liquid at room temperature and includes at least two ethylene oxide functional groups. The epoxide monomer is Part B of the composition for forming the adhesive product.

An amount of metal oxide nanoparticles 504 is added to the epoxide monomer 502 to form a composition 506 of the MO nanoparticles 504 and the epoxide monomer 502. As discussed herein, the amount of MO nanoparticles 504 is defined by the desired high RI of the formed adhesive product. The amount of MO nanoparticles may be in a range of 20 wt. % to 90 wt. % of the total weight of the comonomer composition (epoxide monomer+thiol monomer).

A thiol monomer 508 is added to the composition 506 of the epoxide monomer 502 and MO nanoparticles 504. The thiol monomer 508 is Part A of the composition for forming an adhesive product. The amount to thiol monomer 508 added to the composition 506 is relative to the amount of epoxide monomer 502. In some approaches, a ratio of ethyl oxide functional units on the epoxide monomer (f_{EO}) to thiol functional units on the thiol monomer (f_{SH}) is in a range of 0.5 up to 2.0, and may be higher. In one approach, the ratio of thiol monomer to epoxide monomer may be 1:1.

As illustrated in FIG. 5, a base catalyst 510 may be added with the composition 506 of epoxide/metal oxide and thiol 508 to form the thiol-epoxy-metal oxide polymer network adhesive formulation 512. Nonvolatile amine catalysts are avoided to prevent possible yellowing during light exposure. Amine components, e.g., a base catalyst such as triethylamine, may be included in the mixture, however, preferably, the amine components are volatile and is removed before the mixture is heated during a curing step. Preferably, the catalysts do not colorize the mixture during processing of the product. In some approaches, catalysts may include borate catalysts, hydrides, UV cure initiators, etc. Preferably, the catalyst is not a colorizing agent, such as a colorizing epoxy curing agent (e.g., Jeffamine®), a highly nucleophilic tertiary amine base having a high boiling point (e.g., DABCO), etc.

FIG. 5 illustrate examples of cured adhesive products 514, 516, in accordance with one aspect of an inventive concept. As an option, the present products 514, 516 may be implemented in conjunction with features from any other inventive concept listed herein, such as those described with reference to the other FIGS. Of course, however, such products 514, 516 and others presented herein may be used in various applications and/or in permutations which may or may not be specifically described in the illustrative embodiments listed herein. Further, the products 514, 516 presented herein may be used in any desired environment.

According to one embodiment, a cured adhesive product includes a thiol-epoxy polymer network and metal oxide particles present in the polymer network in an effective amount to cause the cured adhesive product to have a refractive index in a range of about 1.60 to about 1.80. In some approaches, the amount of metal oxide particles is in a range of about 20 weight. % to about 90 weight. % of the total weight of the adhesive product.

For example, as illustrated in FIG. 5, the cured adhesive products 514, 516 are formed by casting the composition of thiol-epoxy-metal oxide nanoparticles as a film, a mold, etc. (as described for method 400, FIG. 4). In one approach, the composition may be cast as a film 514. In another approach, the composition may be cast as a solid flat cylinder 516 (i.e., a puck) from a defined mold.

The properties of the adhesive product material include optical properties, mechanical properties and chemical properties. The optical properties of the adhesive product material include RI tunability in a range of greater than 1.60 to less than 1.80. The refractive indices (RI) of the cured material may be measured over a spectrum of wavelengths using a laser prism coupling system (Metricon, Pennington, NJ). A preferred wavelength for comparison is 532 nm. Application of the adhesive product material in laser cladding uses an RI at 1000 nm. However, the refractive index at the visible wavelength (about 532 nm) is useful for applications that occur at the visible spectrum.

In some approaches, the adhesive product material is essentially colorless such that the transparent material as viewed by human observer has no visual color, no tint of color, etc. (e.g., no tint of yellow, orange, brown, etc.). However, color determination by a human observer tends to be relative. A combination of color measurement systems in transmittance and reflectance modes may be used to determine the color and transparency of the adhesive product. These values may be matched to real life visual perception. The adhesive product may be measured for haze using a haze meter, color and transparency using a spectrophotometer, the measurements will be based on the standards developed by ASTM. The adhesive product material maintains its high RI, transparency, and essentially no color tint over a duration of months, years, etc. For example, the cured adhesive product may be integrated into final applications in a way that avoids discoloration such as yellowing.

For determining color using a UV-Vis spectrophotometer, a raw spectrum may determine color by converting the sample in L*a*b* color coordinates to better articulate yellowness or orangeness on a standard scale. For example, for UV-Vis there is a APHA color scale or “yellowness index.” Control materials may provide a standardized loading for color comparison.

In one preferred approach, the cured adhesive product is optically transparent. The cured adhesive product has a high % Transmission to light, greater than 80% up to near 100%, frequently greater than 95%. In preferred embodiments, the composition may be characterized as being transparent after curing. The cured adhesive product formed from the curable composition has a transparency by allowing light to pass through so that objects behind may be distinctly seen. Transparency of the composition after curing is defined as the cured ink having a luminous transmittance value of at least 85% of light passing through the cured material, e.g., as measured using a conventional transparency measuring technique. Moreover, the haze (e.g., cloudy appearance) of the material is less than 4%. A conventional haze meter may be used to characterize the haze of the cured ink.

In various approaches, the cured adhesive product is essentially free of nitrogen atoms. Typically, it is generally well known that the presence of nitrogen in a cured product will cause the product to change color over time, e.g., yellowing, as the nitrogen is oxidized in the presence of oxygen.

The mechanical properties of the cured adhesive product material include efficient adhesion to a glass surface. The cured adhesive product has a hardness in a Shore A range of greater than 50 to 98. In a preferred approach, the cured adhesive product has a hardness in a Shore A range of greater than 50 up to 90. The chemical properties of the adhesive product material include low outgassing, viscosity consistent with efficient casting of the material into molds during the curing process, MONP compatibility, and efficient cure time (within 24 hours at room temperature).

According to one embodiment, the adhesive product material described herein may be used as high refractive index adhesives or glues for use in laser amplifier cladding applications. As described herein, thiol-epoxy based materials are cured to achieve a refractive index that is higher than 1.60 at 532 nm with Shore A hardness ranging from 50 to 98 and are optically transparent.

Moreover, the adhesive candidate has high optical clarity, low color, and minimal haze for films about 1-2 mm thick (84% Transmission at 532 nm). These approaches enable mapping a process space to allow future customizable adhesive formulations for building a variety of laser systems with tunable refractive index matching for various gain and cladding media.

According to one embodiment, a system includes the cured adhesive product positioned between gain media and cladding. In a preferred approach, the system includes a laser. For example, a fabricated adhesive product may be potted between Ti:Sapphire (e.g., gain media, other high index laser amplification glass, etc.) and a cladding (light absorbing glass) to suppress parasitic oscillation. An adhesive having a high refractive index is preferred to prevent internal reflection of parasitic oscillation light so it can be quenched in the cladding glass cemented around the laser amplifier slab. The adhesive may be tuned to the desired refractive index with desired softness or hardness so the laser amplifier assembly adhesive can absorb stress during operation while helping to suppress parasitic oscillation.

### Examples of Cured Adhesive Products

Thiol-Epoxy Polymer Network Formulations with a Range of Zirconia Nanoparticles

In a preferred embodiment, addition of zirconia to a thiol-epoxy polymer network formulation results in a transparent material. In one approach, a formulation includes a polymer/zirconia network derived from neopentyl glycol diglycidyl ether (NGDE) crosslinked with pentaerythritol tetrakis(mercaptoacetate) (S4). The formulation, without filler (e.g., zirconia nanoparticles), forms a material having a Shore A hardness of about 60 and an RI at about 1.53, as shown in FIG. 6. Progressive addition of zirconia filler shows a linear rise in RI up to 1.69, thereby meeting a minimum RI of about 1.64 at 65 wt. % zirconia. The hardness, however, did not appear to fluctuate with more zirconia added, staying at approximately Shore A of 80-85 for all loading levels. Moreover, the composition demonstrates adhesive properties to a glass surface.

The dashed lines in the plot of FIG. 6 represent the potential loading spaces of zirconia for each comonomer formed with epoxide monomers BADGE, Br₄BADGE, and Epoxide Resin I. Each line starts at the RI of the comonomer listed in the Legend Table. FIG. 6 includes illustrations of the structure of each epoxide monomer and the thiol monomer (S4).

These materials also form optically transparent material with little noticeable haze for films that were cast having a thickness about 1-2 mm. Referring to FIG. 6, an image of S4+NGDE material is in the inset of the plot and an image of S4+Epoxide Resin I material is adjacent the Legend Table. The ease of producing these films with adequate desirable properties shows viability in producing compliant high and variable refractive index materials.

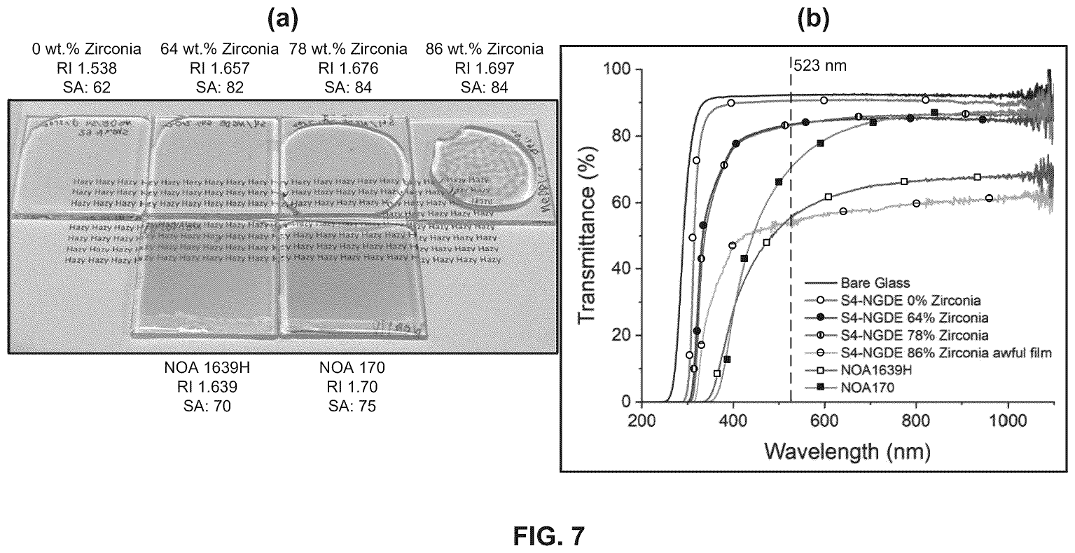

According to one embodiment, loading the comonomer mixture with metal oxide particles raises the RI of the composition and the composition is transparent. FIG. 7 illustrates transparency of sample compositions with different loadings of metal oxide filler (e.g., zirconia particles). The material, about 1 mm thick films, formed from sample compositions were compared to material formed with commercially available adhesives from Norland Products, Inc. (Jamesburg, NJ) (e.g., NOA 1639H and NOA 170). The Norland adhesives are acrylate-based and include zirconia. The sample compositions included a formulation derived from neopentyl glycol diglycidyl ether (NGDE) crosslinked with pentaerythritol tetrakis(mercaptoacetate) (S4). Without filler (0% Zirconia), the material formed from the composition has a Shore A (SA) of about 62 and an RI at about 1.53. For each sample, an increase in zirconia loadings (64 wt. % Zirconia, 78 wt. % Zirconia, 85 wt. % Zirconia) the RI steadily increased and the Shore A hardness remained constant.

Part (a) of FIG. 7 shows images of zirconia-loaded thiol-epoxy polymer network formulations compared to commercially available Norland compositions. Visually, the sample thiol-epoxy polymer network formulations with zirconia are more colorless (upper row of images) in the cured state compared to the yellow-colored commercial formulations (bottom row of images). The sample having the highest loading of zirconia, 86 wt. % Zirconia, shows some surface defects likely from the higher viscosity of the formulation thereby yielding a faster cure rate before deformation could relax (the film was also brittle). The defects of the 85 wt. % Zirconia composition likely account for reduced clarity, however, the composition is colorless. Although the RI increased steadily with increased loading to zirconia, the hardness does not fluctuate with more zirconia added, staying at approximately Shore A of 80 to 85 for all loading levels.

According to one approach, the adhesive formulation does not include inhibitors. It is well known that inhibitors cause a formulation to have a colored tint, e.g., the yellow tint of the commercial formulations (NOA 1639H and NOA 170). Both the NOA commercial formulations include inhibitors, where the polymerization inhibitor monomethyl ether hydroquinone (MEHQ) is present in the final formulation, and the quinones turn color (e.g., yellow, red, etc.).

Opacity of the samples and commercial formulations are shown in the Transmission plot of part (b) of FIG. 7. The % Transmission of each thiol-epoxy/zirconia sample and commercial formulations were measured over a wavelength spectrum. Bare glass represented optimal transparency. At a wavelength of 532 nm the thiol-epoxy polymer network formulations with (64 wt. %, 78 wt. %) and without zirconia demonstrated about 81% Transmission and about 85% Transmission, respectively. The commercially available acrylate-based formulations (NOA) show high haze and residual absorption in the visible spectrum which can limit applications depending on laser wavelength, pumping spectra, etc.

LPU Formulations with Zirconia Nanoparticles (First Strategy)

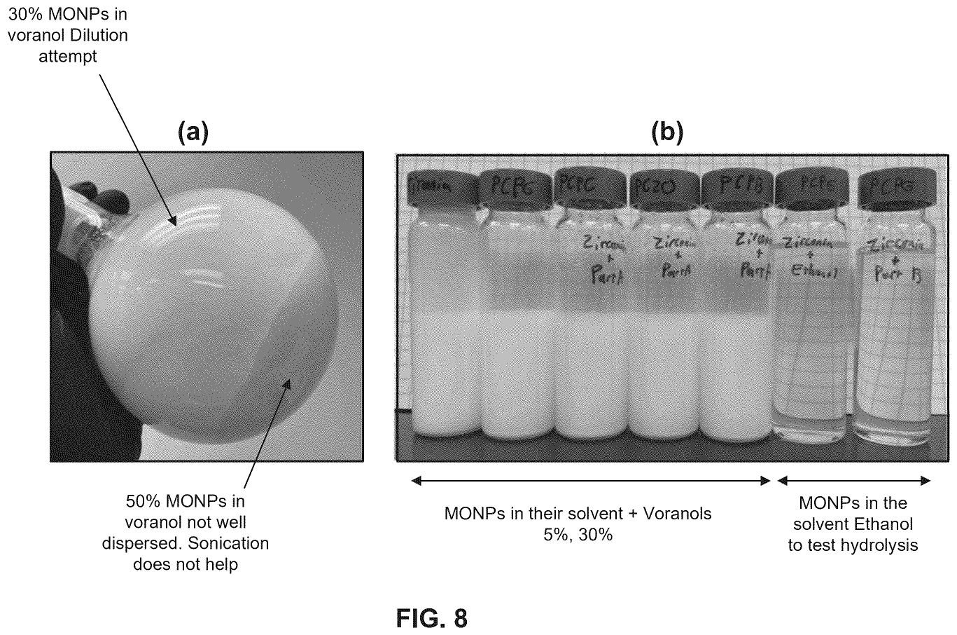

As shown in FIG. 8, zirconia nanoparticles were added to LPU in a carrier solvent to reduce viscosity and promote dispersion, however, the nanoparticles at low concentrations failed to disperse thereby leading to polyol-forming gelatinous intractable masses (image of part (a) and part (b)). As shown in part (a), an attempt to disperse the MONPs and solvent strip the zirconia with polyol (a polyether polyol, voranol) targeting 50 wt. % total zirconia. In part (b), the first 5 vials include 5 wt. % mixtures of solid zirconia plus carrier solvent (1:1 zirconia:solvent) in polyols. In contrast, the MONPs dispersed well into diisocyanate and ethanol (far right two vials, part (b)), indicating that a hydroxyl reaction is not cleaving the organic groups decorating the MONP surfaces. However, once mixed with the polyols, a phase separation occurs yielding white materials with solid masses that are completely impractical and nonfunctional toward a final application. Thus, the first approach as described herein that resulted in insoluble masses was not preferred.

Thiol-Urethane and Thiol-Ene-Click Formulations without Metal Oxide Nanoparticles (Second Strategy)

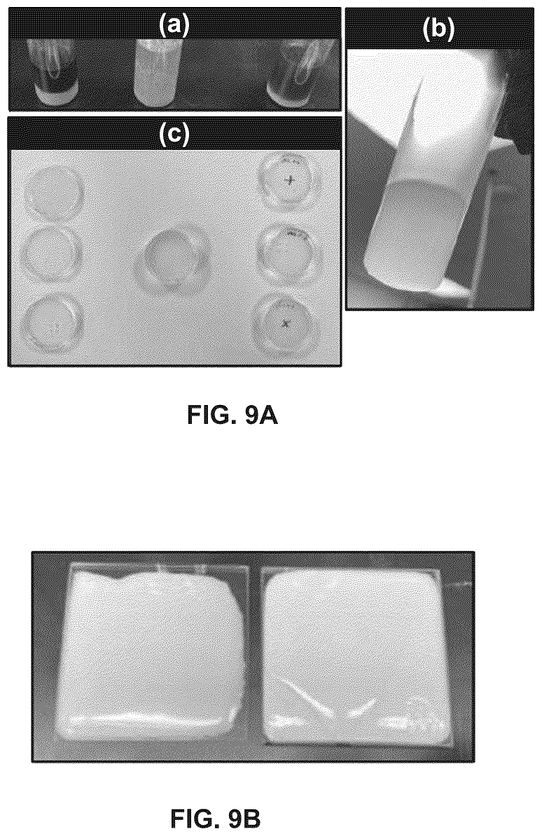

Moreover, in one approach, as shown in part (a) of FIG. 9A, thiolated monomer diisocyanate mixtures resulted in colored mixtures. As shown in part (b), a disulfide containing polyol may not mix adequately with diisocyanates, but over time with heating and continued agitation the viscosity would build and induce dissolution and clarity yielding an exotherm further driving viscosity increase, this however makes processing difficult. In one preparation, resulting films or castings were also far too brittle to be a useful adhesive.

Part (c) of FIG. 9A illustrates samples of thiol-urethane, thiol-ene click, and unfilled epoxy networks that are more facile that yield transparent castings with Shore A hardness from 50 up to 90. However, the mixtures do not have a RI above 1.60.

As shown in FIG. 9B, although zirconia disperses well in thiol-ene-click formulations, once cured under UV light the films are opaque white, and thus not desirable for application of the adhesive.

### Summary of RI and Hardness of Formulations of Cured Adhesive Products

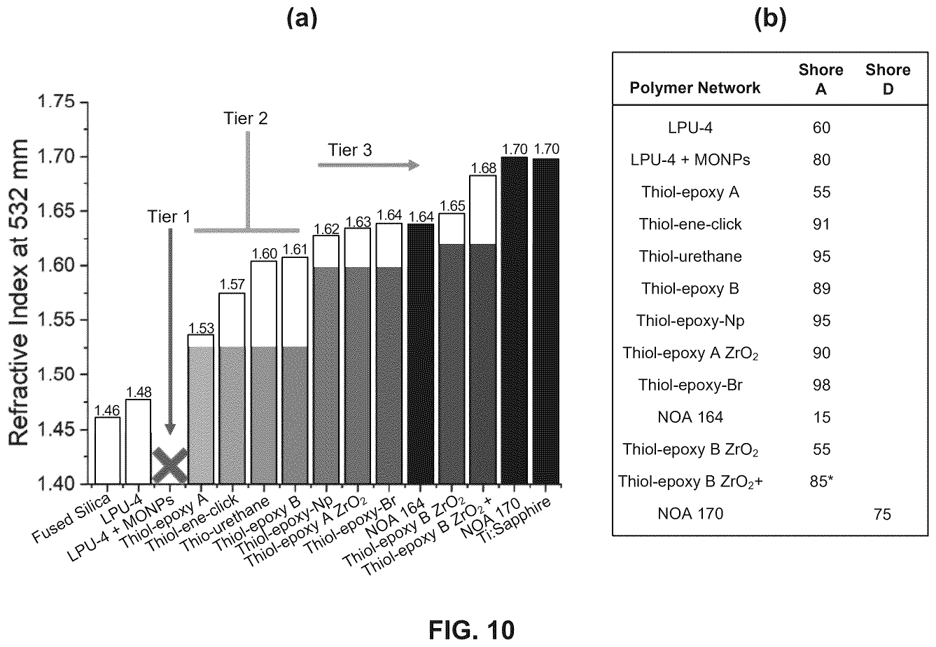

Part (a) of FIG. 10 illustrates the RI of various polymer networks to achieve a match with Ti:Sapphire (e.g., an example of Gain Media) having an RI of 1.70 (far left column). To review, Tier 1 represents the results of Strategy 1 of adding MONPs to LPU-4 that did not result in a homogenous composition. Tier 2 represents the compositions from Strategy 2 that include compositions of thiol-urethane, thiol-ene-click, and thiol-epoxy polymer network formulations. Tier 3 represents the addition of zirconia particles to thiol-epoxy polymer network formulations (cross-hatched pattern). The Tier 3 compositions loaded with zirconia demonstrate the highest RI (1.62 to 1.68) and higher Shore A hardness from 89 to 98. It is interesting that Thiol-epoxy-Np which is a thiol-epoxy polymer network with naphthalene has a high RI relative to Thiol-epoxy polymer network with added zirconia. Moreover, a mixture of Thiol-epoxy-Np may have an intrinsically high RI without added zirconia (i.e., metal oxide nanoparticles).

Hardness determines how much the material can absorb stress. The AMP heads experience large thermal energies that introduce stresses onto the gain media, which would benefit from a stress absorptive adhesive. The competing adhesive technologies are cold bonding or cold condensation. In this method, a laser optic made of glass or ceramic is condensed through surface hydroxyl groups onto an absorbing material made of insulating glass or ceramic. This original approach, without adhesive (the commercial product is no longer available) functions by highly polishing the two pieces of glass and securely joining the pieces together for a prolonged period until the hydroxyl ends condense. A cohesive glass slab is produced, however, with the absence of an adhesive, the sapphire and silicate interface experiences considerable stress from each opposing side due to the substantial differences in their CTEs. Consequently, when the AMP is lasering the edges may shatter, thereby introducing a need for an adhesive which protects the binding between the two glass pieces and allows some degree of movement. The mechanical compliance enables the components to avoid direct contact and fracture due to thermal strain caused by the significant variations in their CTEs. The adhesive is preferably in a range of Shore A 50 to Shore A 90.

The adhesive capability of the adhesive composition is the presence of the epoxide groups that react with the hydroxyls on the surface of the glass. The composition may also include adhesion promoters. In one example, a high loading of zirconia in the adhesive composition provides a secure adhesion, where the adhered film may need a significant amount of energy (e.g., a razor blade) to remove the film from the surface.

For comparison, RIs of the commercial acrylate-based formulations provided by NOA are included and demonstrate high RI, however, the Shore hardness is unsatisfactory being either too soft or too brittle (NOA 164 having a Shore A hardness of 15 and NOA 170 having a Shore D hardness of 75), part (b).

### In Use

Various aspects of an inventive concept described herein may be developed as an adhesive for use in HAPLS-like programs where Ti:Sapphire is the laser amplifier and the adhesive cements, typically Cu-doped glass to the exterior of the optic. This can also be used as an interlayer or adhesive for flexible or rigid display, waveguide, heads up displays, smart eye wear, holographics, or other transparent electronic applications where high refractive index light transport is required.

The inventive concepts disclosed herein have been presented by way of example to illustrate the myriad features thereof in a plurality of illustrative scenarios, aspects of an inventive concept, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various aspects of an inventive concept have been described above, it should be understood that they have been presented by way of example only, and not limitation. Thus, the breadth and scope of an aspect of an inventive concept of the present invention should not be limited by any of the above-described exemplary aspects of an inventive concept but should be defined only in accordance with the following claims and their equivalents.

What is claimed is:

1. A curable composition, comprising:
a thiol monomer;
an epoxide monomer; and
metal oxide nanoparticles,
wherein an amount of the metal oxide nanoparticles is effective to cause a mixture of the thiol monomer, epoxide monomer, and metal oxide nanoparticles to have a refractive index in a range of about 1.60 to about 1.80 after curing of the mixture, wherein the amount of the metal oxide nanoparticles is in a range of about 20 weight % to about 90 weight % of the total weight of the curable composition.

2. The curable composition as recited in claim 1, wherein the thiol monomer is selected from the group consisting of: pentaerythritol tetrakis(mercaptoacetate), 2-hydroxyethyl disulfide, dipentaerythritol hexakis(3-mercaptopropionate), and tris[2-(3-mercaptopropionyloxy)ethyl] isocyanurate.

3. The curable composition as recited in claim 1, wherein the thiol monomer has a molecular structure having at least two mercaptoacetate functional groups.

4. The curable composition as recited in claim 1, wherein the thiol monomer has a molecular structure having four mercaptoacetate functional groups.

5. The curable composition as recited in claim 1, wherein the epoxide monomer has a molecular structure having at least two cyclic ethylene oxide groups.

6. The curable composition as recited in claim 1, wherein the epoxide monomer has an aromatic molecular structure.

7. The curable composition as recited in claim 1, wherein the epoxide monomer is selected from the group consisting of: neopentyl glycol diglycidyl ether, triglycidyl isocyanurate, bisphenol A diglycidyl ether, and tetrabrominated bisphenol A epoxide.

8. The curable composition as recited in claim 1, wherein the metal oxide nanoparticles are selected from the group consisting of: zirconia (ZrO₂), titania (TiO₂), hafnia (HfO₂), tantala (Ta₂O₅), ceria (CeO₂), germania (GeO₂), and yttria (Y₂O₃).

9. The curable composition as recited in claim 1, wherein the metal oxide nanoparticles are pre-mixed in the epoxide monomer.

10. The curable composition as recited in claim 1, further comprising, a base catalyst for promoting a base-catalyzed thiol-epoxy reaction.

11. The curable composition as recited in claim 1, further comprising a curing agent.

12. The curable composition as recited in claim 11, wherein the curing agent is a photoinitiator.

13. The composition as recited in claim 11, wherein the curing agent is a thermal initiator.

14. A cured adhesive product, comprising:
a thiol-epoxy polymer network; and
metal oxide particles present in the polymer network in an effective amount to cause the cured adhesive product to have a refractive index in a range of about 1.60 to about 1.80,
wherein the cured adhesive product is optically transparent,
wherein the cured adhesive product has a hardness in a Shore A range of greater than 50 to less than 90.

15. The cured adhesive product as recited in claim 14, wherein the cured adhesive product is essentially colorless.

16. The cured adhesive product as recited in claim 14, wherein the amount of metal oxide particles is in a range of about 20 weight. % to about 90 weight. % of the total weight of the adhesive product.

17. A system, comprising the cured adhesive product of claim 14 positioned between gain media and cladding.

18. The system of claim 17, wherein the system includes a laser.

19. A method, the method comprising:
obtaining a composition of a thiol monomer, an epoxide monomer, and a predefined amount of metal oxide particles, wherein an amount of the metal oxide particles is effective for causing the composition to have a refractive index in a range of about 1.60 up to about 1.80 upon curing of the composition;
adding a catalyst to the composition; and
curing the composition to form a polymer network having the refractive index and a hardness in a Shore A range of greater than 50 and less than 90.

20. The method as recited in claim 19, further comprising, before curing, applying the composition with the catalyst to a surface to be adhered to another surface by the cured composition.
